(19) United States
(12) Patent Application Publication
(10) Pub. No.: US 2024/0326636 A1
(43) Pub. Date: Oct. 3, 2024

(54) MANAGEMENT DEVICE

(71) Applicant: HONDA MOTOR CO., LTD., Tokyo (JP)

(72) Inventors: Maho Tsujikawa, Tokyo (JP); Yosuke Naito, Tokyo (JP); Yui Nishio, Tokyo (JP)

(21) Appl. No.: 18/585,124

(22) Filed: Feb. 23, 2024

(30) Foreign Application Priority Data
Mar. 28, 2023 (JP) 2023-051296

(51) Int. Cl. B60L 53/68; B60L 53/66; G06Q 30/08; G06Q 50/06

(52) U.S. Cl. CPC B60L 53/68; B60L 53/665; G06Q 30/08; G06Q 50/06

(57) ABSTRACT

Provided is a management device that manages bid to power trading market of electric power which is supplied to power network from a plurality of moving bodies having electrical storage device, the management device including a necessary-number-calculation-part that calculates necessary number of moving bodies required to supply predetermined electrical energy according to time period and the predetermined electrical energy from history of a state of charge of the electrical storage device, a necessary-number-storage that stores necessary number of the moving bodies, an acquisition part that acquires information related to whether the moving bodies can output the electric power to the power network in certain time period, and a bid-power-amount-determining-part that determines bid power amount made to power trading market based on comparison between number of moving bodies that can output the electric power to the power network in the time period and the necessary number of the moving bodies.

### CROSS-REFERENCE TO RELATED APPLICATION

Priority is claimed on Japanese Patent Application No. 2023-051296, filed Mar. 28, 2023, the content of which is incorporated herein by reference.

### BACKGROUND OF THE INVENTION

### Field of the Invention

The present invention relates to a management device.

### Description of Related Art

In recent years, in order to ensure that more people have access to affordable, reliable, sustainable, and advanced energy, research and development has been conducted on charging and supplying power for a mobility equipped with secondary batteries, which contributes to energy efficiency.

In such a technical background, a technology has been disclosed that predicts the amount of power able to be supplied from a vehicle according to the state of charge at a predetermined time and the possibility of connection to EVSE or the predicted number of connections, and further adds a margin to the predicted value to correct the predicted value (for example, see Japanese Unexamined Patent Application, First Publication No. 2021-158835). In this technology, regarding the possibility of connection, it is disclosed that if the position of a vehicle is within a predetermined range of the EVSE, it is determined that there is a possibility of connection.

### SUMMARY OF THE INVENTION

Incidentally, in the technology related to charging and supplying power in mobility equipped with secondary batteries, if the prediction of the number of vehicles is incorrect, there is a risk that the electric power bid will not be able to be supplied. An aspect of the present application is directed to accomplish a technology of more accurately determining a bid power amount in adjustable electric power. Further, it contributes to energy efficiency.

A management device according to the present invention employs the following configurations.

(1) A management device according to an aspect of the present invention is a management device configured to manage a bid to a power trading market of electric power which is supplied to a power network from a plurality of moving bodies having an electrical storage device, the management device including: a necessary number calculation part configured to calculate a necessary number of moving bodies required to supply a predetermined electrical energy according to a time period and the predetermined electrical energy from a history of a state of charge of the electrical storage devices; a necessary number storage configured to store the necessary number of the moving bodies; an acquisition part configured to acquire information related to whether a moving body is capable of outputting the electric power to the power network in a certain time period; and a bid power amount determining part configured to determine a bid power amount made to the power trading market based on comparison between a number of moving bodies that can output the electric power to the power network in the time period and the necessary number of the moving bodies.

(2) In the aspect of the above-mentioned (1), if the number of moving bodies that are able to output the electric power is lower than a necessary number for a first electrical energy, the bid power amount determining part searches for a second electrical energy lower than the first electrical energy in which the number of moving bodies that are able to output the electric power exceeds the necessary number, and sets the second electrical energy as a bid power amount.

(3) In the aspect of the management device of the above-mentioned (1), when the number of moving bodies that are able to be output the electric power exceeds a necessary number in first electrical energy, the bid power amount determining part searches a second electrical energy greater than the first electrical energy in which the number of moving bodies that are to be output the electric power is lower than the necessary number, and sets the next largest electrical energy of the second electrical energy as a bid power amount.

(4) In the aspect of the above-mentioned (1), the necessary number calculation part calculates a daily necessary number from a daily state of charge history of the electrical storage device, the necessary number storage stores a necessary number of a predetermined duration, and the bid power amount determining part determines a bid power amount using a maximum value of the necessary number in the predetermined duration.

(5) In the aspect of any one of claims (1) to (3), the bid power amount determining part determines a bid power amount in a plurality of time periods on a specific day, and determines a bid power amount from the time in which the number of moving bodies that are able to be output the electric power to a power network is relatively small.

(6) In the aspect of the above-mentioned (1), the necessary number is corrected by adding a value obtained by multiplying the calculated necessary number of the moving bodies and/or the bid power amount by a predetermined proportion to the necessary number.

(7) In the aspect of the above-mentioned (1), the necessary number is corrected by adding a necessary number equivalent to the electric power required for the changing when at least some of a plurality of moving bodies are charged in a target time period for bidding.

(8) In the aspect of the above-mentioned (1), a number of moving bodies that are able to be output the electric power is calculated based on prediction of charge starting time or/and a time required for charging from an operation plan of moving bodies upon both determination of a bid power amount and termination of supply of electric power.

(9) In the aspect of the above-mentioned (8), the charge starting time or/and the time required for charging are predicted from one or more operation plans in a unit duration of the moving bodies upon determination of the bid power amount.

(10) In the aspect of the above-mentioned (8) or (9), the charge starting time or/and the time required for charging are predicted from only an operation plan of most recently moving bodies upon termination of supply of electric power.

(11) In the aspect of the management device of the above-mentioned (10), charging of the moving bodies is not performed upon termination of supply of electric power when a difference between the SOC of the moving bodies and the electrical energy required for the operation plan of the most recent moving bodies is greater than a fixed amount.

According to the aspects of the above-mentioned (1) to (11), it is possible to accomplish a technology of more accurately determining a bid power amount in adjustable electric power.

### BRIEF DESCRIPTION OF THE DRAWINGS

FIG. 1 is a view showing a configuration example of a management system including a management device according to an embodiment.

FIG. 2 is a functional block diagram expressing a functional configuration of the management device.

FIG. 3 is a flowchart showing a flow of processing of a total number of vehicles per hour executed by the management device.

FIG. 4 is a flowchart showing a flow of bid power amount determination processing executed by the management device.

FIG. 5 is a view showing a processing example of vehicle elimination processing.

FIG. 6 is a view showing a processing example of first DR-possible time determination processing.

FIG. 7 is a view showing a charging example.

FIG. 8 is a view showing a processing example of second DR-possible time determination processing.

FIG. 9 is a view showing a processing example of total number calculation processing.

FIG. 10 is a view showing a processing example of replacing processing.

FIG. 11 is a view showing a processing example of statistic calculation processing.

FIG. 12 is a view showing a processing example of necessary number calculation processing.

FIG. 13 is a view showing a data example stored in necessary number storage processing.

FIG. 14 is a view showing a processing example of extraction processing.

FIG. 15 is a view showing a processing example of assignment processing.

FIG. 16 is a view showing a case in which SOC is insufficient.

FIG. 17 is a view showing that recovery charging is performed after DR participation.

FIG. 18 is a flowchart showing a flow of determination processing of whether recovery charging is formulated.

FIG. 19 is a view showing an influence by recovery charging.

FIG. 20 is a view showing an example of prediction for frames from 15:00 to 18:00.

FIG. 21 is a view showing a graph of group total recovery charging output.

### DETAILED DESCRIPTION OF THE INVENTION

Hereinafter, an embodiment of a management device of the present invention will be described with reference to the accompanying drawings.

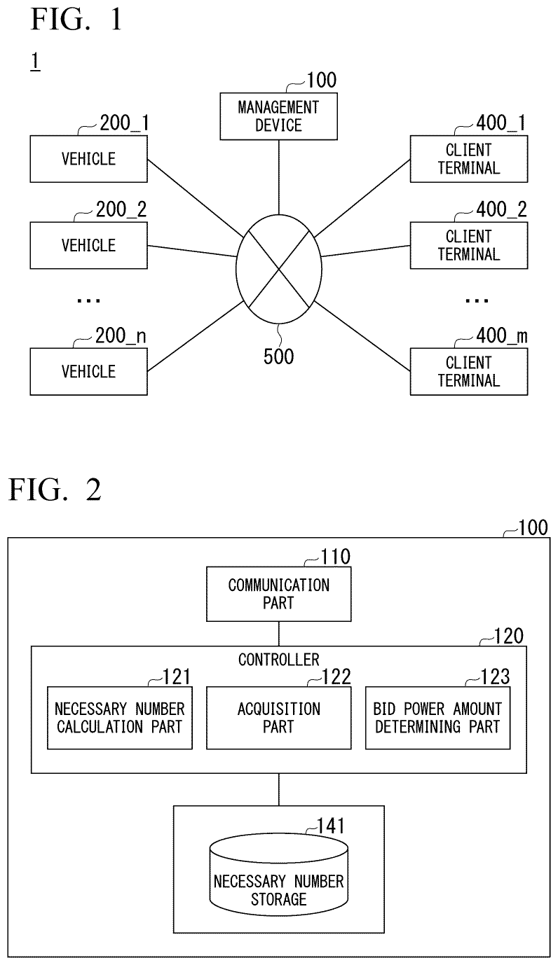

FIG. 1 is a view showing a configuration example of a management system 1 including a management device 100 according to an embodiment of the present invention. The management system 1 includes the management device 100, one or more vehicles 200_1 to 200_n (n is an integer of 1 or more), and one or more client terminals 400_1 to 400_m (m is an integer of 1 or more). Hereinafter, when each of the vehicles 200_1 to 200_n is not to be particularly distinguished, an arbitrary single vehicle is expressed as the vehicle 200. When each of the client terminals 400_1 to 400_m is not particularly discriminated, arbitrary one vehicle is expressed as the client terminal 400.

A network 500 is constituted by a local area network (LAN), a wide area network (WAN), and a mobile telephone network. The management device 100 and the client terminal 400 can communicate with each other via at least a mobile telephone network. The management device 100 and the vehicle 200 can communicate with each other via the LAN or the WAN.

The management device 100 manages a bid for a power trading market of electric power supplied to a power network from a plurality of moving bodies (hereinafter, also referred to as “vehicles”) having electrical storage devices (hereinafter, also referred to as “batteries”). The vehicles 200 are vehicles that can participate in demand response (DR). The client terminal 400 is a terminal of a vehicle in use of the vehicles 200. The client terminal 400 is, for example, a smartphone or a feature phone. In the embodiment, a smartphone will be exemplarily referred to as the client terminal 400.

FIG. 2 is a functional block diagram expressing a functional configuration of the management device 100. The management device 100 includes a central processing unit (CPU), a memory, an auxiliary storage device, or the like, connected by a bus, and functions as a device including a communication part 110, a necessary number storage 141, and a controller 120 by executing a management program. Further, all or some of the functions of the communication part 110, the necessary number storage 141, and the controller 120 may be realized using hardware such as an application specific integrated circuit (ASIC), a programmable logic device (PLD), a field programmable gate array (FPGA), or the like. The management program may be recorded on a computer-readable recording medium. The computer-readable recording medium is, for example, a portable medium such as a flexible disk, a magneto-optical disk, a ROM, a CD-ROM, or the like, or a storage device such as a hard disk or the like installed in a computer system. The management program may be transmitted via an electric telecommunication line.

The communication part 110 is a network interface. The communication part 110 is able to communicate with the vehicle 200 and the client terminal 400 via the network 500.

The controller 120 in FIG. 2 controls operations of parts of the management device 100. The controller 120 is executed by a device including a processor such as a CPU or the like, and a RAM. The controller 120 functions as a necessary number calculation part 121, an acquisition part 122 and a bid power amount determining part 123 by executing a management program.

The necessary number calculation part 121 calculates a necessary number of moving bodies required to supply a predetermined electrical energy according to a time period and a predetermined electrical energy from a history of a state of charge (hereinafter, also referred to as “SOC”) of the electrical storage device. The acquisition part 122 acquires information related to whether output of the moving bodies in a certain time period to a power network is possible. The bid power amount determining part 123 determines a bid power amount to a power trading market based on comparison between the number of moving bodies that can output the electric power to the power network in the time period and the necessary number of moving bodies. In this way, in the embodiment, while the embodiment of determining a bid power amount that is one of adjustable electric power will be described, it is not limited to the bid power amount and may be applied to another purpose. The necessary number storage 141 is configured using a storage device such as a magnetic hard disk device, a semiconductor storage device, or the like. The necessary number storage 141 stores the calculated necessary number of moving bodies.

Next, a flowchart of a flow of processing executed by the management device 100 will be described. In description of the flow of the processing in the flowchart, details of each processing in the flowchart will be described.

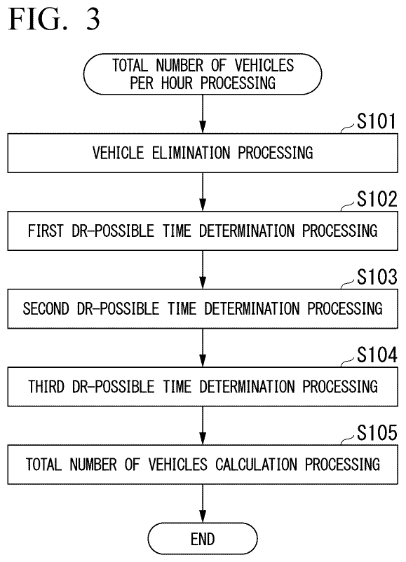

FIG. 3 is a flowchart showing a flow of total number of vehicles per hour processing executed by the management device 100. The flowchart is executed by the acquisition part 122. The management device 100 executes vehicle elimination processing of eliminating a vehicle that cannot participate in the DR (step S101). The management device 100 executes first DR-possible time determination processing (step S102), second DR-possible time determination processing (step S103), and third DR-possible time determination processing (step S104) with respect to the vehicles that are not eliminated in the vehicle elimination processing. On the basis of these processing, the management device 100 executes total number calculation processing of calculating a total number of vehicles that can participate in the DR per each time (step S105).

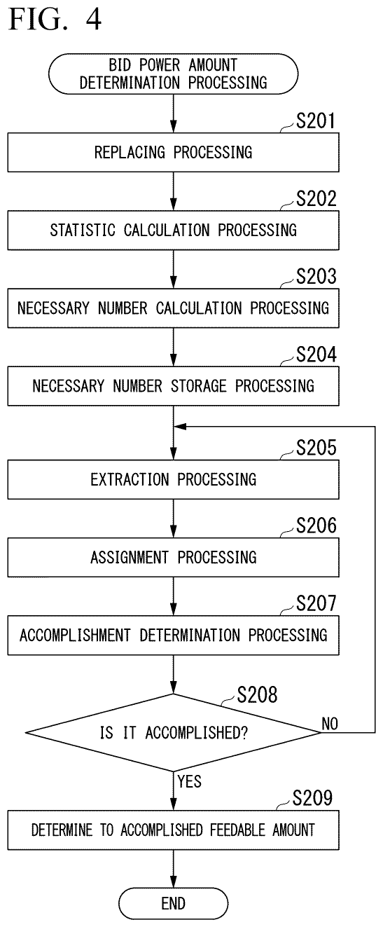

FIG. 4 is a flowchart showing a flow of bid power amount determination processing executed by the management device 100. The management device 100 executes replacing processing of replacing each vehicle SOC with the upper limit discharge amount discharged with the DR (step S201). The management device 100 executes statistic calculation processing of calculating an average SOC and a standard deviation (step S202). The management device 100 executes necessary number calculation processing of calculating the number of vehicles required to supply a feedable amount from the average SOC and the standard deviation (step S203). The management device 100 executes necessary number storage processing of storing the calculated necessary number for one month in the necessary number storage 141 (step S204).

The management device 100 executes extraction processing of extracting a necessary number of vehicles to supply a supply amount as a target (step S205). The management device 100 executes assignment processing of assigning vehicles by a necessary number (step S206). The management device 100 executes accomplishment determination processing of determining whether the assignment is accomplished (step S207). The management device 100 determines whether the assignment is accomplished (step S208). When the assignment is not accomplished (step S208: NO), it advances to step S205. When the assignment is accomplished (step S208: YES), the management device 100 determines that the accomplished feedable amount is the bid power amount (step S209), and terminates the processing. In the processing shown in FIG. 4, step S201 to step S204 are executed by the necessary number calculation part 121. Step S205 to step S209 are executed by the bid power amount determining part 123.

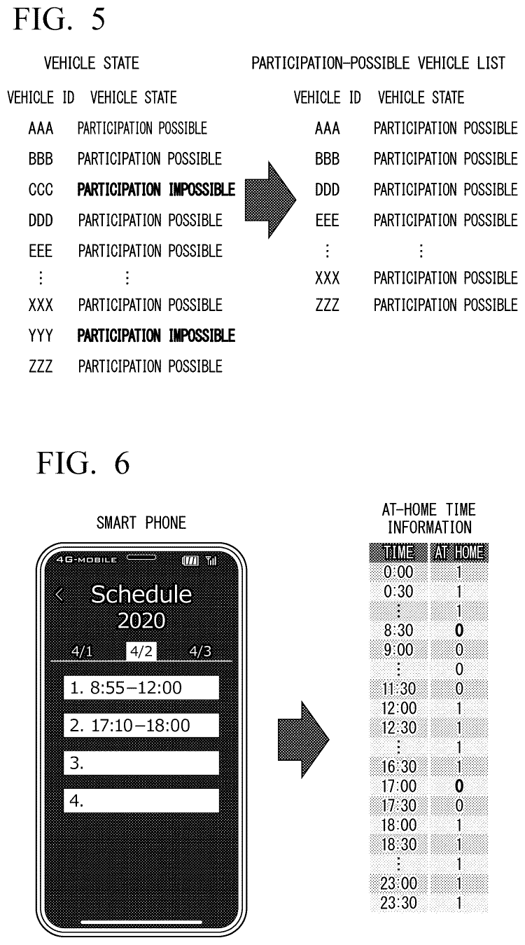

Details of each processing in the flowchart as described above will be described. FIG. 5 is a view showing a processing example of the vehicle elimination processing (step S101). FIG. 5 shows a vehicle state and a participation-possible vehicle list. In FIG. 5, a vehicle ID is information for uniquely identifying a vehicle. The vehicle state is information showing whether the participation is possible. In this way, the management device 100 creates a participation-possible vehicle list in which vehicles whose vehicle status is “participation not possible” have been eliminated in step S101.

FIG. 6 is a view showing a processing example of first DR-possible time determination processing (step S102). FIG. 6 shows an input screen of a smart phone, and at-home time information. As shown in FIG. 6, a vehicle user can use a smart phone to input a time period in which the vehicle will be used, i.e., an operation plan. When the vehicle is used, since the DR participation is impossible, the DR participation for the time period to be used becomes impossible. In the embodiment, in the at-home time information, whether the participation is possible or not is stored as “0” or “1” in “at home” every 30 minutes. “0” shows that participation is impossible, and “1” shows that participation is possible. In addition, “time” indicates time at which the duration of 30 minutes starts from the relevant time. Accordingly, for example, time “17:30” indicates the duration from 17:30 to 18:00. Further, in the embodiment, as an example, “at home” is used, but it is not limited to the home because the vehicle may be any facility that can supply electric power.

For example, as shown in FIG. 6, when a fact that the vehicle is used from 8:55 to 12:00 is input by a user, the management device 100 sets “at home” whose time corresponds to 8:30 to 11:30 to 0. In this way, the management device 100 updates at-home time information according to the time period in which the vehicle is used in step S102. In this way, upon determination of the bid power amount, charge starting time or/and time required for changing is predicted from one or more operation plans in a unit duration (for example, 30 minutes) of the moving bodies. Accordingly, by calculating the number of moving bodies that can output the electric power from each operation plan in an overhead view, the accuracy of calculation of the number of moving bodies can be improved.

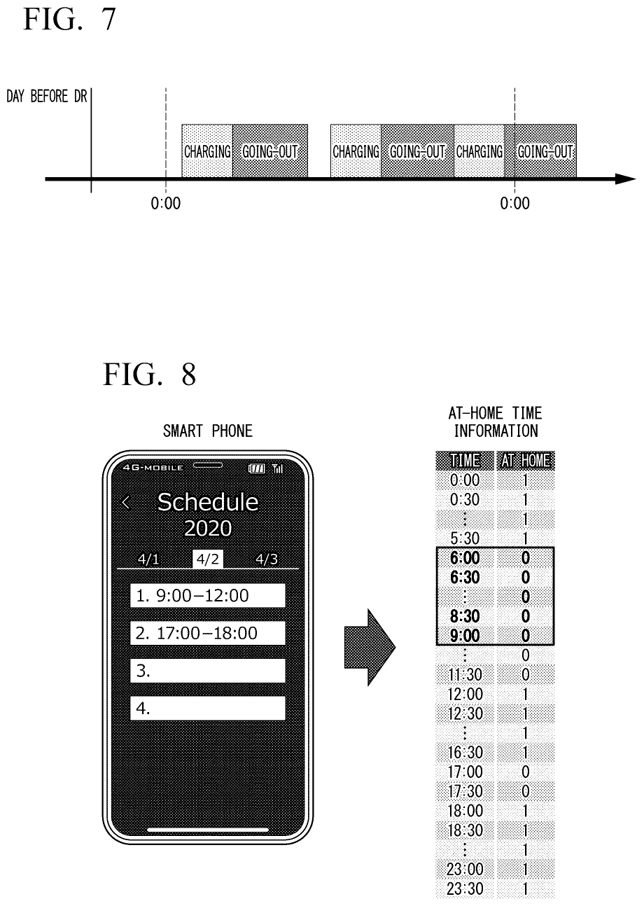

When the vehicle is used by a user, naturally, the electric power of the storage battery of the vehicle is consumed, so the SOC have to be at a certain level at the beginning of use. For this reason, when used after participation in the DR, it may be necessary to charge the battery before use. FIG. 7 is a view showing a charging example. On the day of the DR, it is indicated that the battery should be charged in advance before going out. When charging, that time period cannot participate in the DR.

FIG. 8 is a view showing a processing example of second DR-possible time determination processing (step S103). FIG. 8 shows an input screen of a smart phone, and at-home time information. As shown in FIG. 8, when the user inputs that the vehicle will be used from 9:00 to 12:00, the vehicle state whose time corresponds to 9:30 to 11:30 is set to 0 in step S102 described above. In addition to this, in step S103, the management device 100 assumes that the charging time is 3 hours, and sets the vehicle status corresponding to 6:00 to 8:30 to 0. In this way, the management device 100 updates the at-home time information of the charging time period according to the time period in which the vehicle is used in step S102. Further, the estimation of the charging time to some extent may be estimated based on the predicted SOC by predicting the SOC at the time when the vehicle starts to be used.

Next, the third DR-possible time determination processing (step S104) will be described. In the third DR-possible time determination processing, the management device 100 calculates the recovery charging time when electric power is consumed as the vehicle participates in the DR, and sets “at home” of the at-home time information corresponding to the calculated recovery charging duration to 0.

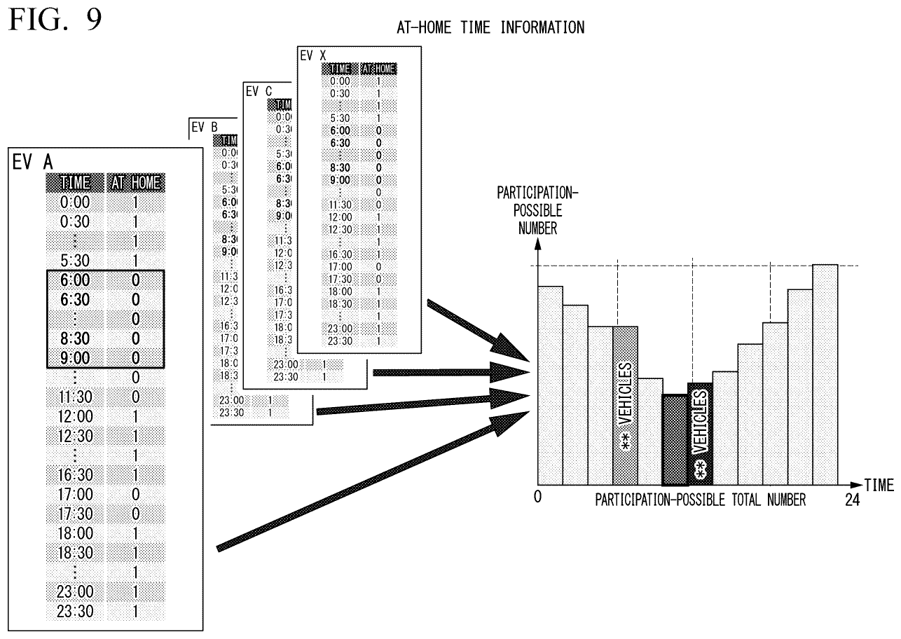

FIG. 9 is a view showing a processing example of the total number calculation processing (step S105). FIG. 9 shows at-home time information and a participation-possible total number for each of the vehicles (EV A, . . . , EV X). The management device 100 can calculate a participation-possible number for each time period by adding the at-home time information of each vehicle for each time period. The participation-possible total number indicates the participation-possible number for each time period. The participation-possible total number is stored in a storage device such as a RAM, a hard disk, or the like.

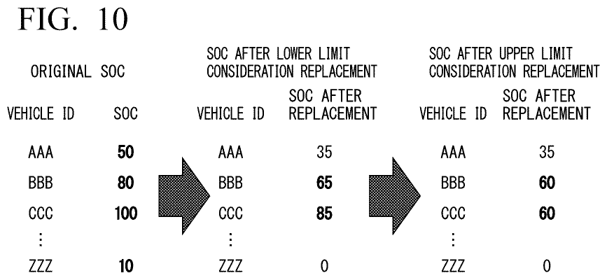

Next, bid power amount determination processing shown in FIG. 4 will be described. FIG. 10 is a view showing a processing example of the replacing processing (step S201). The replacing processing is shown in FIG. 10 in a day, which shows the original SOC, the SOC after lower limit consideration replacement, and the SOC after upper limit consideration replacement. In addition, FIG. 10 shows an example in which the SOC of the vehicle whose vehicle ID is AAA, BBB, . . . , ZZZ is an object. In addition, an example in which the lower limit SOC is set as 15%, a maximum supply amount per one vehicle upon DR participation is set as the upper limit SOC, and this is set as 60% is shown.

The management device 100 subtracts the lower limit SOC 15% from the original SOC. Accordingly, for example, the SOC of the vehicle whose vehicle ID is AAA becomes 50−15=35%. Next, for the management device 100, in order to set the upper limit to 60%, all vehicles whose SOC after lower limit consideration replacement exceeds 60% are set to 60%. For example, for the vehicle ID BBB, the SOC after lower limit consideration replacement exceeds 60%, so the SOC after lower limit consideration replacement is 60%. In this way, in step S201, the management device 100 executes replacing processing to replace each vehicle SOC with an upper limit discharge amount to be discharged in the DR.

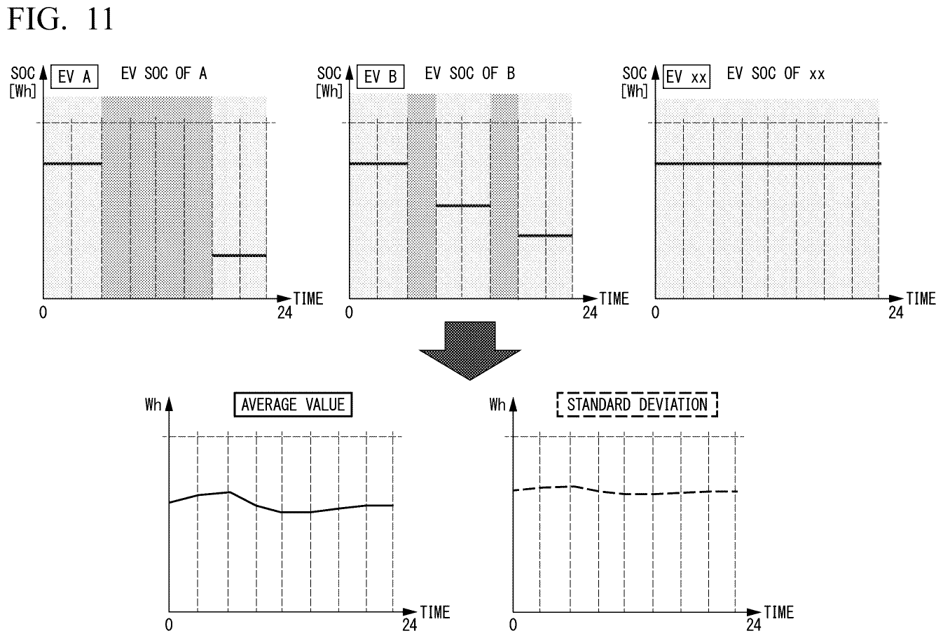

FIG. 11 is a view showing a processing example of the statistic calculation processing (step S202). FIG. 11 shows the SOC from 0:00 to 24:00 in the previous day of a participation date of the DR of three vehicles (EV A, EV B, EV xx), and average values and standard deviations of those. For example, in the SOC of the EV A, values in duration of several hours from 0:00 and several hours before 24:00 are shown on a straight line. A time period where a straight line does not exist indicates a time period where participation in the DR is not possible, such as when going out. The average value indicates an average value of the SOC of each vehicle, and the standard deviation indicates a standard deviation of the SOC of each vehicle. The average value and the standard deviation shown in FIG. 11 are calculated from the SOC of each vehicle by a block unit (for example, a 3-hour unit). The average value and the standard deviation are calculated at the end of each day and stored for a predetermined duration, e.g. 30 days. In this way, in step S202, the management device 100 executes statistics calculation processing of calculating the average value and the standard deviation.

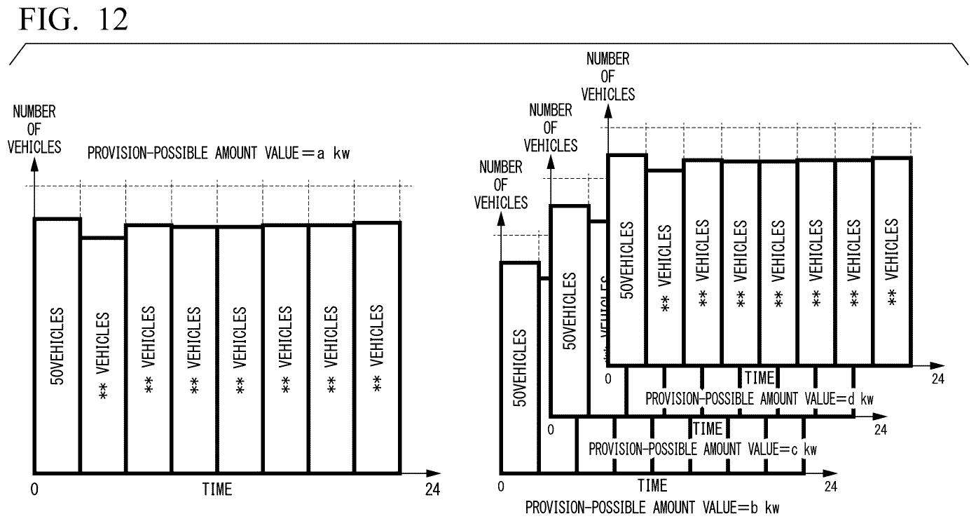

FIG. 12 is a view showing a processing example of the necessary number calculation processing (step S203). In the necessary number calculation processing, the necessary number is calculated for each feedable quantity value. FIG. 12 is a view showing a graph showing a necessary number to set a feedable quantity value for each time period for each of feedable quantity values a to d (kw). A lateral axis represents time, and a vertical axis represents a necessary number.

A method of calculating the necessary number calculates a relation between “the vehicle number” and “distribution of the average SOC of the vehicle number” from the average value and the standard deviation. Here, calculation is performed using a central limit theorem in which the average SOC when extracting a certain number of n vehicles becomes the normal distribution.

Specifically, n indicates a necessary number of the vehicles, Pt indicates a target value of resource provision success probability as the management system 1, SOCt indicates a sample average of time upon extraction of n vehicles, and SOCp indicates an average SOC upon extraction of n vehicles that satisfy Pt % inclusion. With respect to the average SOC obtained at probability P of Pt % or more upon extraction of n vehicles,
P (SOCt<SOCp)=1-Pt is standardized, and
it is set as P (Z<(SOCp-AVE_SOC)/(σ/(√n))=1−Pt. Here, AVE_SOC is the above mentioned average value, and o is a standard deviation of the time.

Here, z that is 1-Pt from the standard normal distribution table is searched, and it becomes (SOCp-AVE_SOC)/(σ/(√n)=z . . . (Equation 1). Further, it is also possible to directly determine z without determining Pt.

Next, the necessary number to output the electric power only when supply output KWt (kw) is set as n. In addition, EVSE is set as an EVSE available amount, and DRt is set as a DR participation time per vehicle.

$$n = ( KWt / EVSE ) \times ( ( EVSE \times DRt ) / ( SOCp \times efEVSE ) ) \qquad ( Equation 2 )$$

A first item (KWt/EVSE) on the right side of this equation indicates the necessary number from the viewpoint of a charger, and a second item (EVSE×DRt)/(SOCp×efEVSE) indicates the necessary magnification when considering the SOC.

Equation 1 and Equation 2 are combined to calculate n. Specifically, for example, in Equation 1, the following Equation is obtained by finding the SOCp and substituting the found SOCp into Equation 2.

$$√ n = ( - b \pm √ ( b \times b - 4 \times c ) ) / 2 \qquad ( Equation 3 )$$

Here, b and c are as follows.

$$b = ( z \times σ ) / AVE\_SOC \\ c = - ( KWt \times DRt ) / ( AVE\_SOC \times efEVSE )$$

By squaring both sides of Equation 3, n can be obtained.

As described above, the necessary number n is calculated by substituting the average value obtained by the statistic calculation processing for AVE_SOC, substituting the standard deviation obtained by the statistic calculation processing for σ, and substituting the feedable quantity value for KWt. In the case of FIG. 12, the necessary numbers are shown when a, b, c and d are substituted for KWt, respectively. In this way, the management device 100 executes necessary number calculation processing of calculating the number of vehicles required to supply a feedable amount from the average SOC and the standard deviation.

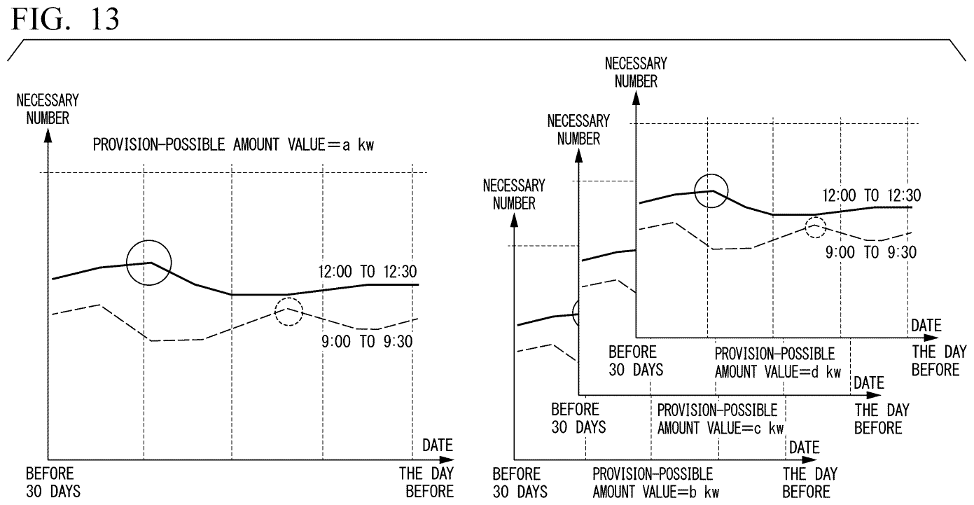

FIG. 13 is a view showing a data example stored in the necessary number storage processing (step S204). In the processing described in FIG. 12, the necessary number is obtained in one day unit, and this is stored within a predetermined duration (for example, 30 days). FIG. 13 is a view showing a graph showing the number of vehicles required to set a feedable quantity value for each time period in each of feedable quantity values a to d (kw). A lateral axis shows the date, and a vertical axis shows the necessary number. In FIG. 13, changes in the number of vehicles in the time period of 12:00 to 12:30 and the time period of 9:00 to 9:30 are shown as an example. A place surrounded by a circle in the graph shows a maximum value of the number. The data shown in the graph are stored in the necessary number storage 141. In this way, the management device 100 executes necessary number storage processing of storing the calculated necessary number in the necessary number storage 141 only for one month.

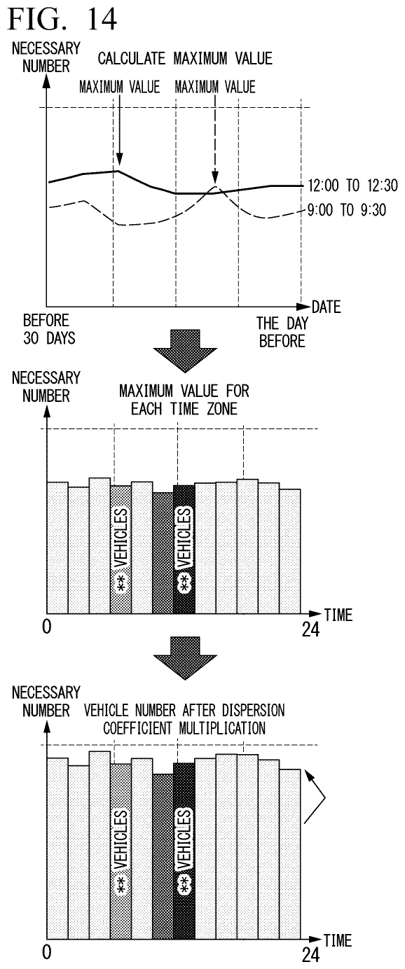

FIG. 14 is a view showing a processing example of the extraction processing (step S205). FIG. 14 shows a graph described in FIG. 13, a graph showing a maximum value for each time period, and a graph showing the number of vehicles after the dispersion coefficient multiplication. In the graph showing the maximum value for each time period and the graph showing the number of vehicles after dispersion coefficient multiplication, a lateral axis represents time and a vertical axis represents the necessary number of vehicles.

In the graph described in FIG. 13, the management device 100 calculates the number of vehicles, which is a maximum value, and acquires it as the maximum value for each time period. Then, a value obtained by multiplying the acquired maximum value by a dispersion coefficient is set as the necessary number of the vehicles. The dispersion coefficient should be set to a large number just in case, and a value obtained empirically may be used. In this way, the management device 100 executes extraction processing of extracting the necessary number of the vehicles to supply the supply amount as the target. Then, the necessary number of the vehicles is corrected by adding the value obtained by multiplying the calculated necessary number of the vehicles by a predetermined proportion to the necessary number of the vehicles. Alternatively, the bid power amount is corrected by adding the value obtained by calculating the bid power amount and multiplying the calculated bid power amount by the predetermined proportion to the bid power amount. Accordingly, when the necessary number of the vehicles and the bid power amount are low, a bid can be made with a small margin, and when they are high, electric power can be supplied with a sufficient margin even if the calculation error of the necessary number becomes large. As a result, calculation accuracy of the necessary number of the vehicles can be improved.

The necessary number calculation part 121 calculates a daily necessary number of the vehicles from a state of charge history of a daily electrical storage device, the necessary number storage 141 stores the necessary number of the vehicles in a predetermined duration (30 days), and the bid power amount determining part 123 determines the bid power amount using the maximum value of the necessary number of the vehicles in the predetermined duration. Accordingly, by determining the bid amount using the maximum value of the past necessary number for the number of DR participation vehicles, it is possible to secure the target available amount of electrical energy to be supplied after bidding.

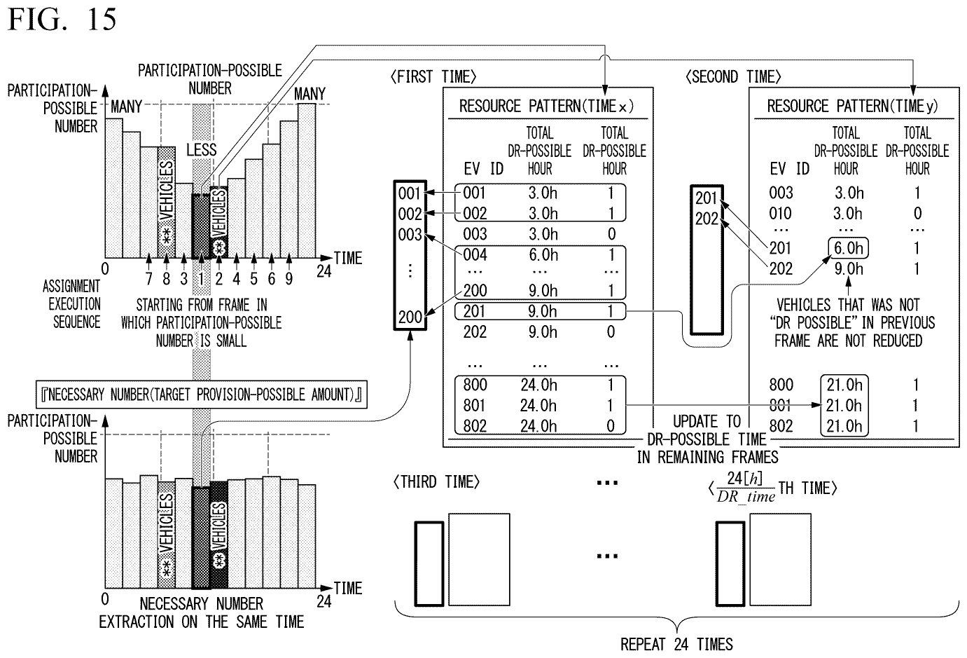

FIG. 15 is a view showing a processing example of the assignment processing (step S206). FIG. 15 shows a graph showing the number of partition-possible vehicles, and a graph showing the necessary number. The graph showing the number of partition-possible vehicles is a graph obtained by the total number of vehicles per hour processing of FIG. 3 (see FIG. 9). The graph showing the necessary number of the vehicles is a graph described in FIG. 14. In addition, the graph showing the necessary number of the vehicles may be, for example, a graph showing a necessary number to determine a supply amount that could be supplied on the previous day.

The management device 100 assigns vehicles according to the necessary number. Here, in the graph showing the number of participation-possible vehicles, the management device 100 performs assignment in sequence of frames (time periods) in which the number of participation-possible vehicles is small. In FIG. 15, numerical characters described below the lateral axis in the graph showing the number of participation-possible vehicles indicate sequence in the example of FIG. 15. For example, when the time period is 30 minutes (corresponding to “DR_time” in the drawings), 48 assignments from first to 48th are performed in 24 hours/30 minutes. In this way, the bid power amount determining part 123 determines the bid power amount in the plurality of time periods on a specific day (the day of participation in the DR), and determines the bid power amount from the time when the number of moving bodies that can output the electric power to the power network is relatively small. Further, the assignment may be made in chronological order in consideration of leaving the participation-possible vehicles at times when the number of moving bodies that can output the electric power to the power network is relatively small. Accordingly, contract probability can be increased by determining the bid power amount with priority from the time period in which the number of participation-possible vehicles to the DR is small (i.e., it is difficult to secure the necessary number).

FIG. 15 shows first and second assignments. In the first assignment, a resource pattern in time x is shown. The resource pattern shows the vehicle ID (EV ID in the drawings), total DR-possible hours, and DR-possible time information for each vehicle. The total DR-possible hours show participation-possible hours in the DR. The DR-possible time information shows whether participation in the DR is possible at the corresponding time. “0” shows that the participation is impossible, and “1” shows that the participation is possible. The management device 100 assigns the necessary number of participation-possible vehicles to the DR in the resource pattern. While the resource pattern at the second time y is assigned in the same way, the time is calculated by subtracting the time assigned for the first time from the total DR-possible hour of the vehicle that has already been assigned for the first time. For example, in the vehicle whose EV ID is 201, while the total DR hours at the first time is 9 hours, the total DR hours become 6 hours by subtracting 3 hours from 9 hours at the time y. Hereinafter, for example, when the block is 3 hours, the assignment is performed to 8th assignment.

In the assignment processing, it returns to “1” as the assignment accomplishment information when the assignment is accomplished, and it returns to “0” as the assignment accomplishment information when the assignment is not accomplished. When the assignment processing is terminated, the management device 100 executes accomplishment determination processing (step S207). Step S205 to step S208 including step S207 become loop processing. M^{th} loop processing in the loop processing is expressed as “m^{th} loop.”

In the first loop, when the assignment processing returns to “1,” there is a possibility that the available amount can be increased. Meanwhile, in the first loop, when the assignment processing returns to “0,” it is necessary to reduce the available amount.

Here, in the first loop, when the assignment accomplishment information is “0,” the management device 100 reduces the available amount by a predetermined amount, makes a negative determination in step S208, proceeds to step S205, and performs the second loop processing. Then, in the m^{th} (m≥2) loop processing, when the assignment accomplishment information is “0,” the available amount is further reduced by a predetermined amount, and the (m+1)^{th} loop processing is executed. In the m^{th} (m≥2) loop processing, when the assignment accomplishment information is “1,” it is determined that the assignment is accomplished, and the accomplished feedable amount is determined in step S209.

Meanwhile, in the accomplishment determination processing, in the first loop, when the assignment accomplishment information is “1,” the management device 100 increases the available amount by a predetermined amount, makes a negative determination in step S208, proceeds to step S205, and performs the second loop processing. Then, in the m^{th} (m≥2) loop processing, when the assignment accomplishment information is “1,” the available amount is further increased by a predetermined amount, the (m+1)^{th} loop processing is executed. In the m^{th} (m≥2) loop processing, when the assignment accomplishment information is “0,” it is determined that the assignment is accomplished for the (m−1)^{th} time, and the accomplished feedable amount is determined in step S209.

In this way, when the number of moving bodies that can output the electric power is lower than the necessary number in the first electrical energy (available amount), the bid power amount determining part 123 searches the second electrical energy smaller than the first electrical energy in which the number of moving bodies that can output the electric power is higher than the necessary number (the electrical energy reduced from the first electrical energy by a predetermined amount), and sets the second electrical energy as the bid power amount. Accordingly, while avoiding the situation where the bid electric power cannot be supplied, it is possible to bid the maximum target available amount for which the necessary number has been secured, and more electrical energy can be supplied to the power network.

In addition, when the number of moving bodies that can output the electric power is higher than the necessary number in the first electrical energy (available amount), the bid power amount determining part 123 searches the second electrical energy greater than the first electrical energy in which the number of moving bodies that can output the electric power is lower than the necessary number (the electrical energy increased from the first electrical energy by a predetermined amount), and sets the next largest electrical energy of the second electrical energy as the bid power amount. Accordingly, it is possible to bid the maximum target available amount for which the necessary number has been secured, and more electrical energy can be supplied to the power network.

As described above, according to the embodiment, the bid power amount in the adjustable electric power can be determined more accurately. Accordingly, it is possible to suppress the event that the bid electric power cannot be supplied.

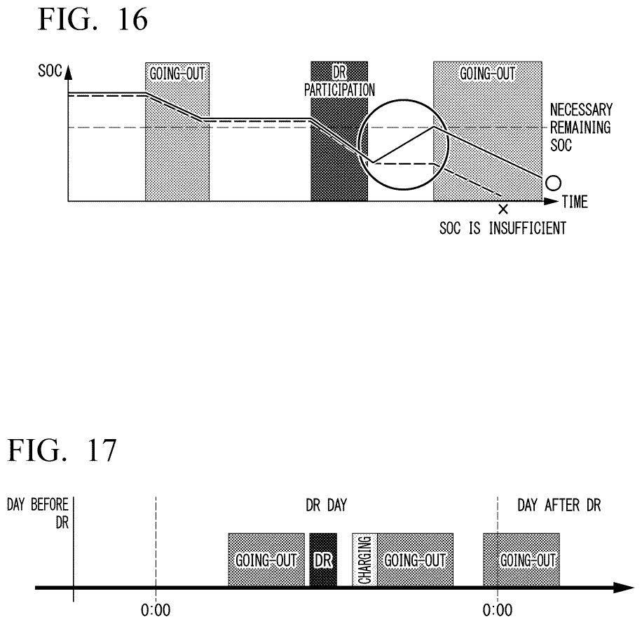

Next, in the above-mentioned embodiment, the mode of charging after DR participation will be described. After the DR participation, when a vehicle is planned to be used, there may be a shortage of the SOC. FIG. 16 is a view showing a case in which the SOC is insufficient. As shown in FIG. 16, it is conceivable that the vehicle's participation in the DR may cause a lack of the SOC while the vehicle is going-out. In this case, recovery charging is required before going-out, and a charging plan thereof needs to be formulated. Here, the management device 100 determines whether the charging plan is formulated, and formulates the recovery charging according to the determination result.

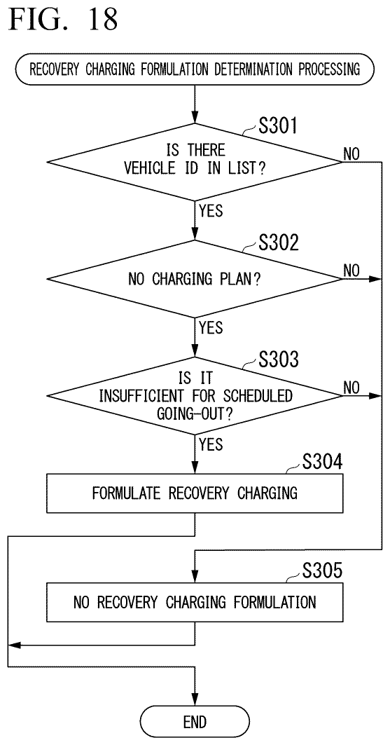

For this reason, as shown in FIG. 17, the recovery charging is performed after the DR participation. FIG. 18 is a flowchart showing a flow of processing of determining whether the recovery charging is formulated. In FIG. 18, the management device 100 determines whether the vehicle ID of the vehicle that is an object to be determined is in the list participating in the DR (step S301). When the vehicle ID of the vehicle that is the object to be determined is not in the list participating in the DR (step S301: NO), the management device 100 does not formulate the recovery charging (step S305), and terminates the processing.

When the vehicle ID of the vehicle that is the object to be determined is in the list participating in the DR (step S301: YES), the management device 100 determines whether there is no charging plan between after the DR participation and the going-out (step S302). When there is a charging plan (step S302: NO), the management device 100 does not formulate the recovery charging (step S305), and terminates the processing. When there is no charging plan (step S302: YES), the management device 100 determines whether the current SOC is insufficient for the scheduled going-out (step S303). When the current SOC is not sufficient for the scheduled going-out (step S303: NO), the management device 100 does not formulate the recovery charging (step S305), and terminates the processing. When the current SOC is insufficient for the scheduled going-out (step S303: YES), the management device 100 formulates the recovery charging (step S304), and terminates the processing.

In this way, when the electric power supply ends, the charge starting time or/and prediction of the time required for charging is made only from the operation plan of the most recent moving body. Accordingly, electric power shortages for the latest operation plan can be avoided, and the accuracy of calculation of optimal charging electric power can be further improved. In addition, upon termination of the electric power supply, when the difference between the SOC of a moving body and the electrical energy required for the operation plan of the most recent moving body (for example, a difference that prevents the SOC from running out during the going-out of the moving body) is greater than a certain level, charging to the moving body is not performed. Accordingly, by avoiding unnecessary charging, battery deterioration can be reduced.

In relation to this recovery charging, how to formulate a charging plan that allows the DR participation vehicle to secure the SOC for driving on the DR participation day will be described. For example, the charging plan that allows the DR participation vehicles to secure the SOC for driving on DR participation days is formulated using the DR hour termination time as a trigger.

An example of the activation condition for formulation processing is when the time matches the end date and time of the contract information with the set value. The set value is time before a certain time (reference value: 15 minutes) in consideration of the FB control calculation time of the next time period when the object vehicle contracts the DR participation in consecutive time periods.

The management device 100 outputs the vehicle ID of the vehicle that participates or has participated in the DR during the contract duration. The management device 100 acquires the following information (departure time, charging mode) using the vehicle ID.

Referring to the departure time and/or planned input information input from the client terminal 400, the earliest departure time that is later than the current time is acquired. Further, when the obtained charging gun mated state shows that it is not mated, formulation of the charging plan is stopped.

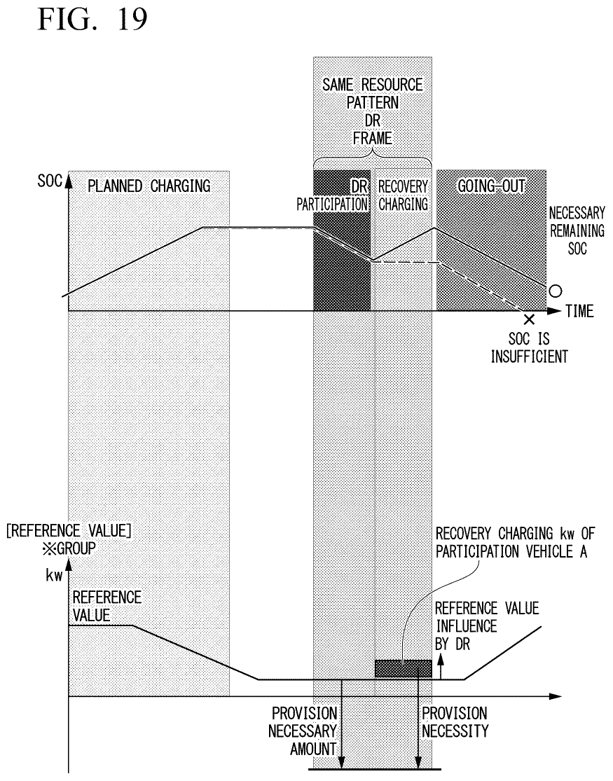

Further, as shown in FIG. 19, although it has been decided to participate in the DR in the plurality of time periods, due to the above-mentioned recovery charging being formulated, unscheduled charging may occur in the time period where the participation was scheduled. In this case, since the provision amount and the charge amount cancel each other out, it is necessary to compensate the supply amount that was originally supposed to be supplied.

When the compensation becomes necessary, the management device 100 first calculates the recovery charging time and the charger output that overlap with the DR participation prediction time. In the following description, one time period is expressed as a “frame,” and the frames are expressed as a first frame, a second frame, and the like, in sequence from 24:00.

The recovery time and the charger output of the following vehicle are acquired with respect to prediction of a k^{th} frame.

A: Vehicle allocated by DR distribution on the day before prediction object date.

B: In the case of k>1, DR1 to assignment vehicle of (k−1)^{th} frame.

However, if there is the same vehicle (the same vehicle ID) in A and B, they will be treated without distinction from now on. Then, it is assumed that one device will be charged even if the recovery charging time is incurred.

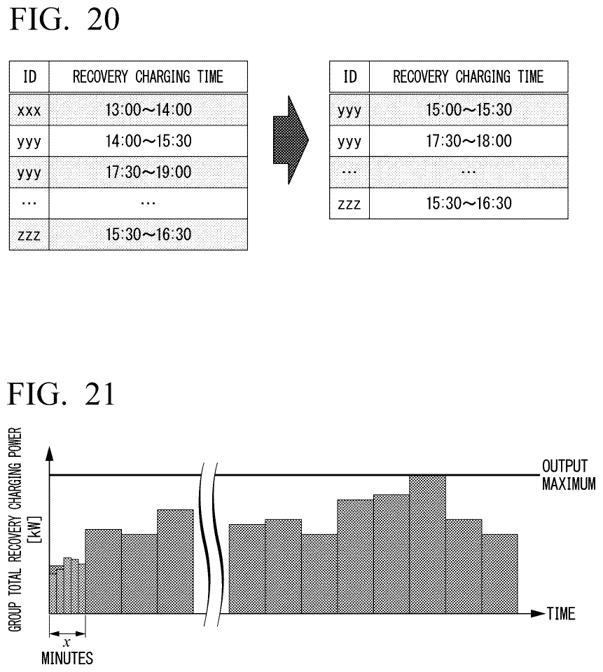

Then, the management device 100 extracts the recovery charging time that covers the DR time of the k^{th} frame among the recovery charging time. This will be described with reference to FIG. 20. FIG. 20 is a view showing an example of prediction with respect to a frame of 15:00 to 18:00. As shown in the recovery charging time on the left side of FIG. 20, the recovery charging time of the vehicle whose vehicle ID is yyy becomes 14:00 to 15:30 or 17:30 to 19:00. Accordingly, the time overlapping the recovery charging time of the vehicle whose vehicle ID is yyy becomes 15:00 to 15:30 and 17:30 to 18:00 as shown on the right side.

Next, the management device 100 calculates the recovery charging average output and the maximum output (group) in the DR prediction time. The management device 100 calculates a recovery charging average output A using the following equation.

$$A = ( \sum a ( i ) \times b ( i ) ) / c$$

Here, Σ represents a sum related to i. Here, a(i) represents a recovery charging time (hour), b(i) represents a system-side charging output (kw), and c represents a DR participation-possible time per one vehicle.

Next, the management device 100 calculates the average maximum output every x minutes using the following equation.

$$B = max ( \sum d ( j , i ) \times b ( i ) ) / x )$$

Here, max relates to j, and 2 represents a sum related to i. Here, x indicates time of one frame of the time period in which the vehicle participates in the DR. One frame of the time period in which the vehicle participates in the DR is assigned as each of x(1), x(2) . . . , x(j), . . . , and the recovery charging time (min) in the frame j is set as d (j, i).

Next, when the average output of the recovery charging is calculated and the necessary number in terms of kWh is calculated (case a), the necessary number is acquired as follows. That is, the necessary number when providing e(kW) acquires the necessary number that is equal to or greater than (e+A) (kW) and corresponds to the minimum provision amount.

Meanwhile, as shown in FIG. 21, there is a limit to discharge output, and even if the battery capacity is sufficient, it may not be possible to output. In this case, when the group total recovery charging output (kW), which is the sum of the recovery charging outputs of the plurality of vehicles, is the maximum, the discharge output needs to be the maximum. When the maximum output of recovery charging is calculated in this way and the required number of vehicles from the kW viewpoint (case b) is calculated, the necessary number is acquired as shown below. That is, the number of vehicles required to instantaneously provide (e+B) (KW) is calculated as follows using system-side discharging output (EVSE available amount) f (kW/vehicle).

$$Necessary number ( vehicles ) = ( e + B ) / f$$

A larger value among the necessity number of the vehicles obtained in a case a and the necessity number of the vehicles calculated in a case b is set as the necessity number of the vehicles at the time of e-supply.

In this way, when at least some of the plurality of moving bodies are charging in the target time period being bid, the necessary number of the vehicles is corrected by adding the necessary number of the vehicles equivalent to the electric power required by the such charging. Accordingly, considering that the electric power supply amount decreases due to charging, the calculation accuracy of the necessary number of the vehicles can be improved.

In addition, as described in FIG. 7, the number of moving bodies that can output the electric power is calculated based on the prediction of the charge starting time or/and the time required for charging from the operation plan of the moving bodies before determining the bid power amount. Accordingly, both when determining the bid power amount and ending supply of the electric power, the number of moving bodies that can output the electric power is calculated based on the prediction of the charge starting time or/and the time required for charging from the operation plan of the moving bodies. Accordingly, by calculating the number of moving bodies that can output the electric power based on the latest situation in the plurality of periods, the accuracy of calculation can be improved.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A management device configured to manage a bid to a power trading market of electric power which is supplied to a power network from a plurality of moving bodies having an electrical storage device, the management device comprising:
a necessary number calculation part configured to calculate a necessary number of moving bodies required to supply a predetermined electrical energy according to a time period and the predetermined electrical energy from a history of a state of charge of the electrical storage devices;
a necessary number storage configured to store the necessary number of the moving bodies;
an acquisition part configured to acquire information related to whether a moving body is capable of outputting the electric power to the power network in a certain time period; and
a bid power amount determining part configured to determine a bid power amount made to the power trading market based on comparison between a number of moving bodies that can output the electric power to the power network in the time period and the necessary number of the moving bodies.

2. The management device according to claim 1, wherein, if the number of moving bodies that are able to output the electric power is lower than a necessary number for a first electrical energy,
the bid power amount determining part searches for a second electrical energy lower than the first electrical energy in which the number of moving bodies that are able to output the electric power exceeds the necessary number, and sets the second electrical energy as a bid power amount.

3. The management device according to claim 1, wherein, when the number of moving bodies that are able to be output the electric power exceeds a necessary number in first electrical energy,
the bid power amount determining part searches second electrical energy greater than the first electrical energy in which the number of moving bodies that are to be output the electric power is lower than the necessary number, and sets the next largest electrical energy of the second electrical energy as a bid power amount.

4. The management device according to claim 1, wherein the necessary number calculation part calculates a daily necessary number from a daily state of charge history of the electrical storage device,
the necessary number storage stores a necessary number of a predetermined duration, and
the bid power amount determining part determines a bid power amount using a maximum value of the necessary number in the predetermined duration.

5. The management device according to claim 1, wherein the bid power amount determining part determines a bid power amount in a plurality of time periods on a specific day, and
determines a bid power amount from the time in which the number of moving bodies that are able to be output the electric power to a power network is relatively small.

6. The management device according to claim 1, wherein the necessary number is corrected by adding a value obtained by multiplying the calculated necessary number of the moving bodies and/or the bid power amount by a predetermined proportion to the necessary number.

7. The management device according to claim 1, wherein the necessary number is corrected by adding a necessary number equivalent to the electric power required for the changing when at least some of a plurality of moving bodies are charged in a target time period for bidding.

8. The management device according to claim 1, wherein a number of moving bodies that are able to be output the electric power is calculated based on prediction of charge starting time and/or a time required for charging from an operation plan of moving bodies upon both determination of a bid power amount and termination of supply of electric power.

9. The management device according to claim 8, wherein the charge starting time or/and the timer required for charging are predicted from one or more operation plans in a unit duration of the moving bodies upon determination of the bid power amount.

10. The management device according to claim 8, wherein the charge starting time or/and the time required for charging are predicted from only an operation plan of most recently moving bodies upon termination of supply of electric power.

11. The management device according to claim 10, wherein charging of the moving bodies is not performed upon termination of supply of electric power when a difference between the SOC of the moving bodies and the electrical energy required for the operation plan of the most recent moving bodies is greater than a fixed amount.
